(19) United States
(12) Patent Application Publication
(10) Pub. No.: US 2012/0027253 A1
(43) Pub. Date: Feb. 2, 2012

(54) ILLUMINATION APPARATUS AND BRIGHTNESS ADJUSTING METHOD

(75) Inventors: LUNG DAI, Tu-Cheng (TW); SHAO-LIN ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/043,622

(22) Filed: Mar. 9, 2011

(30) Foreign Application Priority Data
Aug. 2, 2010 (TW) 99125576

(51) Int. Cl. G06K 9/00

(52) U.S. Cl. 382/103

(57) ABSTRACT

An illumination apparatus comprises a control unit, an image capturing unit, a processor unit, a comparison unit, an adjustment unit and an illumination unit. The control unit generates a start signal in a predetermined time. The image capturing unit captures a plurality of images of ambient road condition according to the start signal. The processor unit extracts the edges of the vehicle from the captured images to obtain a current traffic. The adjustment unit generates different pulse voltages according to the different volume of traffic. The illumination unit emits light according to the different pulse voltages.

### BACKGROUND

1. Technical Field

The present disclosure relates to illumination apparatuses; and particularly to a street lamp and a brightness adjusting method used by the street lamp.

2. Description of Related Art

Light emitting diodes (LEDs) are widely used in many applications, such as in a LED street lamp. However, the LEDs often emit light according to a predetermined current supplied by a constant current source, such that the brightness of the street lamp maintains a constant brightness regardless of any change in traffic. This is an inconvenience.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout three views.

FIG. 1 is a block diagram of an illumination apparatus in accordance with one exemplary embodiment.

FIG. 2 is a flow chart of a brightness adjusting method in accordance with one exemplary embodiment.

FIG. 3 is a flow chart of a brightness adjusting method in accordance with another embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

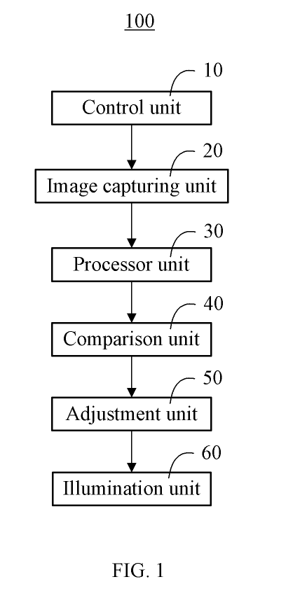

Referring to FIG. 1, an illumination apparatus 100 includes a control unit 10, an image capturing unit 20, a processor unit 30, a comparison unit 40, an adjustment unit 50 and an illumination unit 60.

The control unit 10 is used for generating a start signal and transmitting the start signal to the image capturing unit 20 in a predetermined time. The predetermined time can be adjusted by a user.

The image capturing unit 20 is used for capturing a list of the current images of road conditions in response to each start signal and outputs the captured images to the processor unit 30. In the embodiment, the image capturing unit 20 is a camera set around the illumination unit 60.

The processor unit 30 is used for computing the captured images to obtain a current traffic. In the embodiment, the volume of current traffic is computed based on the size of the captured images. The traffic is in direct proportion to the size or amount of memory required to store the captured images. That is to say, when the traffic increases, the size of the captured images increases, and when the traffic decreases, the size of the captured images decreases. In the other embodiments, the processor unit 30 extracts the edge of the vehicle from the captured images to obtain the number of the vehicles.

The comparison unit 40 is used for comparing the current traffic with a predetermined value and generating a control signal according to a comparison result between the current traffic and the predetermined value. In the embodiment, the comparison unit 40 includes a first predetermined value and a second predetermined value, and the first predetermined value is larger than the second predetermined value. If the size of the captured images is at least the first predetermined value, the comparison unit 40 generates a first control signal. If the size of the captured images is between the first predetermined value and the second predetermined value, the comparison unit generates a second control signal. If the size of the captured images is at maximum the second predetermined value, the comparison unit 40 generates a third control signal. The comparison unit 40 includes more than two different predetermined values such as three different predetermined values 1M, 3M and 5M where M represent megabytes. If the size of the captured images is at least 5M, the comparison unit 40 generates a first control signal. If the size of the captured images is between 3M and 5M, the comparison unit 40 generates a second control signal. If the size of the captured images is more than 1M but at most 3M, the comparison unit 40 generates a third control signal. If the size of the captured images is at most 1M, the comparison unit 40 generates a fourth control signal.

The adjustment unit 50 is used for generating pulse voltages in response to the control signals. The adjustment unit 50 generates a first pulse voltage in response to the first control signal. The adjustment unit 50 generates a second pulse voltage in response to the second control signal, and the duty cycle of the second pulse voltage is less than that of the first pulse voltage. The adjustment unit 50 stops generating a pulse voltage in response to the third control signal.

The illumination unit 60 may be a LED lamp, and is used for emitting light according to the phase voltage of the adjustment unit 50.

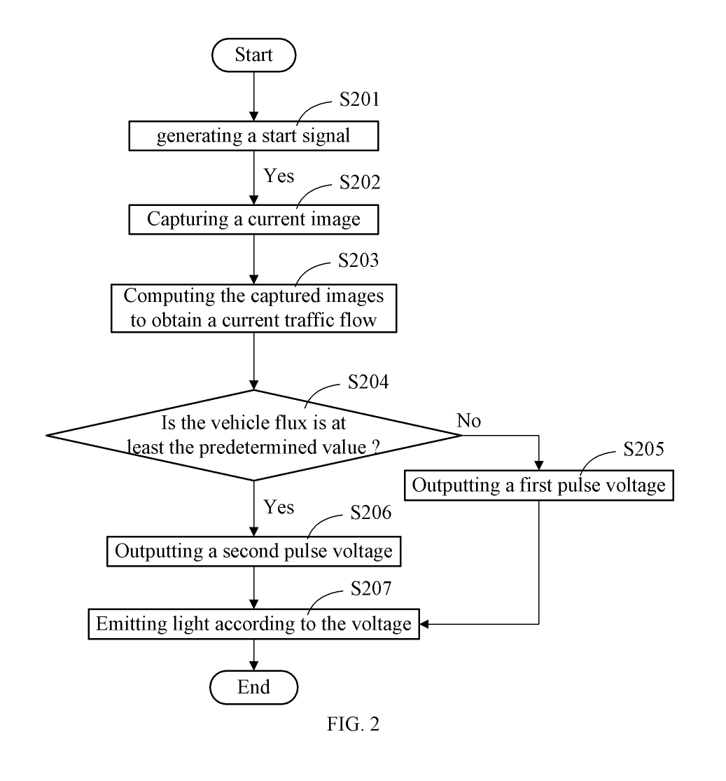

Referring to FIG. 2, a brightness adjusting method is used to adjust the brightness of the illumination apparatus. The adjusting method includes the following steps.

In step S201, the control unit generates a start signal in a predetermined time. The predetermined time can adjust by a user.

In step S202, the image capturing unit captures a list of the current images of the road conditions.

In step S203, the processor unit processes the captured images to obtain a current traffic. In the embodiment, the traffic is processed based on size of the captured images. The traffic is in direct proportion to the size of the captured images. That is to say, when the traffic increases, the size of the captured images increases, and when the traffic decreases, the size of the captured images decreases. In the other embodiment, the processor unit extracts the contour of the vehicle from the captured images to obtain the number of the vehicles.

In step S204, it is determined that whether the current traffic is at least a predetermined value. If the current traffic is at least the predetermined value, the comparison unit generates a first control signal and step S205 is implemented. If the current traffic is less than the predetermined value, the comparison unit generates a second control signal and step S206 is implemented.

In step S205, the adjustment unit generates a first pulse voltage according to the first control signal.

In step S206, the adjustment unit generates a second pulse voltage according to the second control signal.

In step S207, the illumination unit emits light according to the pulse voltage.

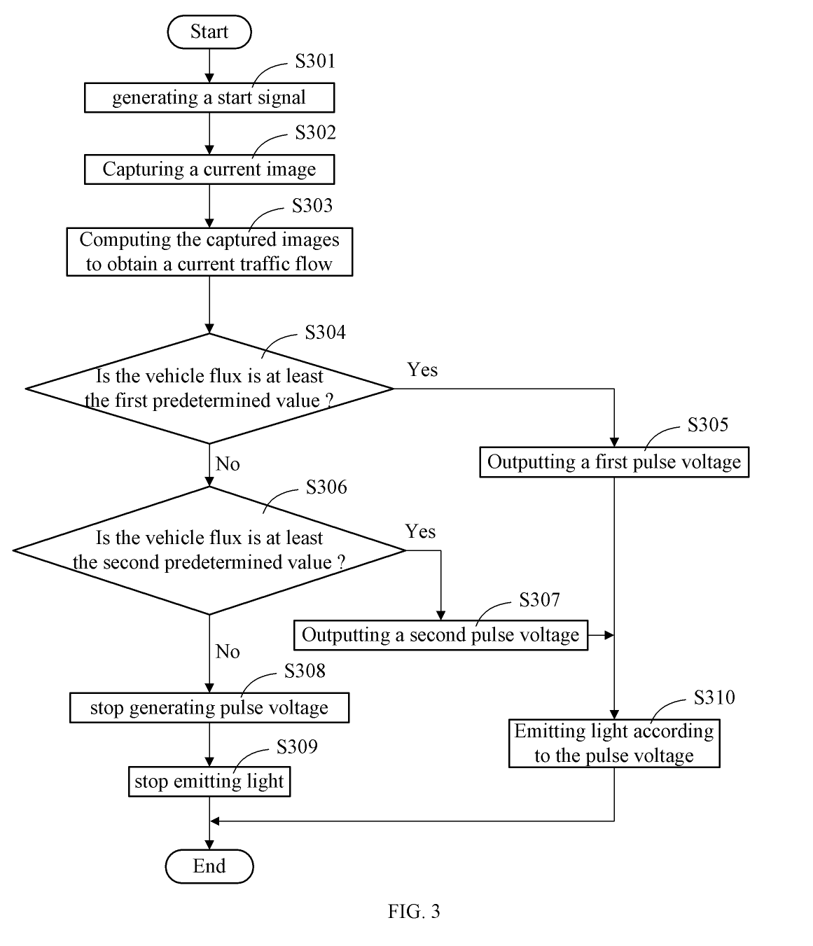

Referring to FIG. 3, in the other embodiments, the comparison unit comprises a first predetermined value and a second predetermined value and the first predetermined value is larger than the second predetermined value. The step S301-S303 in FIG. 3 are respectively the same as the step S201-S203 in FIG. 2. The adjusting method further comprises the following steps.

In step S304, it is determined that whether the current traffic is at least the first predetermined value. If the current traffic is at least at the first predetermined value, the comparison unit generates a first control signal and step S305 is implemented. If the current traffic is less than the first predetermined value, step S306 is implemented.

In step S305, the adjustment unit generates a first pulse voltage according to the first control signal and step S310 is implemented.

In step S306, it is determined that whether the current traffic is at least at the second predetermined value. If the current traffic is at least at the second predetermined value, the comparison unit generates a second control signal and step S307 is implemented. If the current traffic is less than the second predetermined value, the comparison unit generates a third control signal and step S308 is implemented.

In step S307, the adjustment unit generates a second pulse voltage according to the second control signal and step S310 is implemented.

In step S308, the adjustment unit stops generating the pulse voltage according to the third control signal.

In step S309, the illumination unit stops emitting light.

In step S310, the illumination unit emits light according to the pulse voltage.

Using the above adjusting method, the illumination apparatus can adjust the luminous intensity according to the traffic of the road conditions, thus the life of the illumination apparatus will be increased.

It is to be understood, even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An illumination apparatus comprising:
an image capturing unit adapted to capture the image of ambient road condition;
a processor unit adapted to extract the edges of the vehicle from the captured images to obtain current traffic;
an adjustment unit adapted to generate different pulse voltages according to different volume of traffic; and
an illumination unit adopted to emit light according to the pulse voltage.

2. The illumination apparatus of claim 1, wherein the illumination apparatus further comprises a comparison unit, and the comparison unit is used for determining whether the traffic is at least a predetermined value and generate a control signal.

3. The illumination apparatus of claim 2, wherein the comparison unit comprises a first predetermined value and a second predetermined value, if the traffic is at least the first predetermined value, the comparison unit generates a first control signal, the adjustment unit generates a first pulse voltage according to the first control signal.

4. The illumination apparatus of claim 3, wherein the first predetermined value is larger than the second predetermined value.

5. The illumination apparatus of claim 3, wherein if the traffic is less than the first predetermined value but at least the second predetermined value, the comparison unit generates a second control signal and the adjustment unit generates a second pulse voltage according to the second control signal, the duty cycle of the pulse voltage is less than that of the first control signal.

6. The illumination apparatus of claim 3, wherein if the traffic is less than the second predetermined value, the comparison unit generates a third control signal, the adjustment unit stop generating pulse voltage according to the third control signal.

7. The illumination apparatus of claim 1, wherein the traffic is computed based on size of the captured images.

8. The illumination apparatus of claim 1, wherein the illumination apparatus further comprises a control unit adapted to generate a start signal in a predetermined time to the image capturing unit, the image capturing unit captures a plurality of the images of ambient road condition according to the start signal.

9. The illumination apparatus of claim 1, wherein the illumination unit is a LED street lamp, the image capturing unit is a camera set around the illumination unit.

10. A brightness adjusting method adapted to adjusting the brightness of an illumination apparatus, the adjusting method comprising:
capturing a list of the current images of ambient road condition;
processes the captured images to obtain current traffic;
generating different pulse voltages according to the volume of traffic; and
the illumination apparatus emitting light according to the pulse voltage.

11. The method according to claim 10, wherein the illumination apparatus comprises a first predetermined value and a second predetermined value and the first predetermined value is larger than the second predetermined value.

12. The method according to claim 11, further comprising a step of determining whether the current traffic is at least the first predetermined value;
if the current traffic is at least the first predetermined value, generating a first control signal; and
generating a first pulse voltage according to the first control signal.

13. The method according to claim 12, wherein if the current traffic is less than the first predetermined value, determining whether the current traffic is at least the second predetermined value;
if the traffic is at least the second predetermined value, generating a second pulse voltage; and
the illumination unit emitting light according to the second pulse voltage.

14. The method according to claim 13, wherein if the current traffic is less than the second predetermined value, stop generating pulse voltage; and
the illumination unit stop emitting light.
the illumination unit emitting light according to the first pulse voltage.

15. The method according to claim 10, wherein the traffic is computed based on the size of the captured images.

16. The method according to claim 10, wherein the illumination apparatus is a LED street lamp.

17. The method according to claim 10, wherein the traffic is computed base on the number of the vehicles of the captured images.
